(19) United States
(12) Patent Application Publication
(10) Pub. No.: US 2025/0004606 A1
(43) Pub. Date: Jan. 2, 2025

(54) ADDING, PLACING, AND GROUPING WIDGETS IN EXTENDED REALITY (XR) APPLICATIONS

(71) Applicant: Samsung Electronics Co., Ltd., Suwon-si (KR)

(72) Inventors: Ajinkya Waghulde, Castro Valley, CA (US); Edgar Charles Evangelista, San Jose, CA (US); Hiroshi Horii, Pleasanton, CA (US); Yujie Jiang, Santa Clara, CA (US); Sooryuh Kim, Seoul (KR); Minkyung Cho, Seoul (KR); Boosun Shin, Seoul (KR); Sungman Kim, Seoul (KR); Chaekyung Lee, Gwacheon-si (KR)

(21) Appl. No.: 18/752,157

(22) Filed: Jun. 24, 2024

Related U.S. Application Data
(60) Provisional application No. 63/523,436, filed on Jun. 27, 2023.

(51) Int. Cl. G06F 3/04815; G06F 3/01; G06F 3/16; G06T 19/00

(52) U.S. Cl. CPC G06F 3/04815; G06F 3/013; G06F 3/017; G06F 3/167; G06T 19/006

(57) ABSTRACT

A method includes rendering a semi-transparent or opaque board on a display of an XR headset, such that the board does not overlap with at least one real-world object. The method also includes receiving a first user input to open a widget library. The method also includes rendering a grid structure on the board after receiving the first user input. The method also includes receiving a second user input to select a widget from the widget library. The method also includes receiving a third user input to move the selected widget to the grid structure on the board. The method also includes placing the selected widget at a position in the grid structure on the board. The method also includes stopping rendering the grid structure, while displaying the selected widget at the position on the board, with an orientation determined based at least partly on a user's head position.

### CROSS-REFERENCE TO RELATED APPLICATIONS AND PRIORITY CLAIM

This application claims priority under 35 U.S.C. § 119 (e) to U.S. Provisional Patent Application No. 63/523,436 filed on Jun. 27, 2023, and is related to U.S. patent application Ser. No. 18/746,306 filed on Jun. 18, 2024, the disclosures of which are hereby incorporated by reference in their entirety.

### TECHNICAL FIELD

This disclosure relates generally to extended reality (XR) systems and processes. More specifically, this disclosure relates to adding, placing, and grouping widgets in XR applications.

### BACKGROUND

Extended reality (XR) is an umbrella term encompassing augmented reality (AR), virtual reality (VR), and mixed reality (MR). In the domain of XR, the user's experience is significantly enriched by the user's ability to interact with and manipulate virtual objects or software components, often referred to as “widgets.” These widgets, such as virtual buttons, sliders, or other control elements, form one method for user interaction within the XR environment.

### SUMMARY

This disclosure relates to adding, placing, and grouping widgets in extended reality (XR) applications.

In a first embodiment, a method includes rendering, by a processor, a semi-transparent or opaque board on a display of an extended reality (XR) headset in communication with the processor, such that the board does not overlap with at least one real-world object recognized by the processor. The method also includes receiving, by the processor, a first user input to open a widget library. The method also includes rendering, by the processor, a grid structure on the board after receiving the first user input. The method also includes receiving, by the processor, a second user input to select a widget from the widget library. The method also includes receiving, by the processor, a third user input to move the selected widget to the grid structure on the board. The method also includes placing, by the processor, the selected widget at a position in the grid structure on the board. The method also includes stopping, by the processor, rendering the grid structure, while displaying the selected widget at the position on the board, with an orientation determined based at least partly on a user's head position. In some aspects of the first embodiment, the second user input and the third user input comprise images of the user's eyes captured using an eye tracking camera coupled to the XR headset. In some aspects of the first embodiment, the second user input comprises images of the user's eyes captured using an eye tracking camera coupled to the XR headset, and the third user input comprises a voice input from the user.

In a second embodiment, an electronic device includes at least one processing device configured to render a semi-transparent or opaque board on a display of an XR headset in communication with the at least one processing device, such that the board does not overlap with at least one real-world object recognized by the at least one processing device. The at least one processing device is also configured to receive a first user input to open a widget library. The at least one processing device is also configured to render a grid structure on the board after receiving the first user input. The at least one processing device is also configured to receive a second user input to select a widget from the widget library. The at least one processing device is also configured to receive a third user input to move the selected widget to the grid structure on the board. The at least one processing device is also configured to place the selected widget at a position in the grid structure on the board. The at least one processing device is also configured to stop rendering the grid structure while displaying the selected widget at the position on the board, with an orientation determined based at least partly on a user's head position. In some aspects of the second embodiment, the second user input and the third user input comprise images of the user's eyes captured using an eye tracking camera coupled to the XR headset. In some aspects of the second embodiment, the second user input comprises images of the user's eyes captured using an eye tracking camera coupled to the XR headset, and the third user input comprises a voice input from the user.

In a third embodiment, a non-transitory machine-readable medium contains instructions that when executed cause at least one processor of an electronic device to render a semi-transparent or opaque board on a display of an XR headset in communication with the at least one processor, such that the board does not overlap with at least one real-world object recognized by the at least one processor. The instructions also cause the at least one processor to receive a first user input to open a widget library. The instructions also cause the at least one processor to render a grid structure on the board after receiving the first user input. The instructions also cause the at least one processor to receive a second user input to select a widget from the widget library. The instructions also cause the at least one processor to receive a third user input to move the selected widget to the grid structure on the board. The instructions also cause the at least one processor to place the selected widget at a position in the grid structure on the board. The instructions also cause the at least one processor to stop rendering the grid structure while displaying the selected widget at the position on the board, with an orientation determined based at least partly on a user's head position. In some aspects of the third embodiment, the second user input and the third user input comprise images of the user's eyes captured using an eye tracking camera coupled to the XR headset. In some aspects of the third embodiment, the second user input comprises images of the user's eyes captured using an eye tracking camera coupled to the XR headset, and the third user input comprises a voice input from the user.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIGS. 2A and 2B illustrate example XR views showing virtual boards and virtual grids according to this disclosure;

FIG. 3 illustrates an example technique for a user to define a grid layout according to this disclosure;

FIG. 4 illustrates an example XR space in which a widget library panel can be displayed according to this disclosure;

FIG. 5 illustrates an example image XR space in which the user selects an ‘Add’ button to add a widget, according to this disclosure;

FIGS. 6A through 6C illustrate various techniques for searching for empty cell locations according to this disclosure;

FIG. 7 illustrates an example XR view in which a table surface includes a real world object, according to this disclosure;

FIGS. 8A and 8B illustrate example techniques for moving widgets according to this disclosure;

FIG. 9 illustrates an example of the use of constraints on a grid surface when moving a widget according to this disclosure;

FIG. 10 illustrates an example of moving an existing widget to place a new widget, according to this disclosure;

FIGS. 11A and 11B illustrate examples for handling widgets of different sizes according to this disclosure;

FIG. 12 illustrates an example XR view showing widget orientation on a surface according to this disclosure;

FIG. 13 illustrates an example of widget tilt according to this disclosure; and

FIG. 14 illustrates an example method for adding widgets in an XR application according to this disclosure.

### DETAILED DESCRIPTION

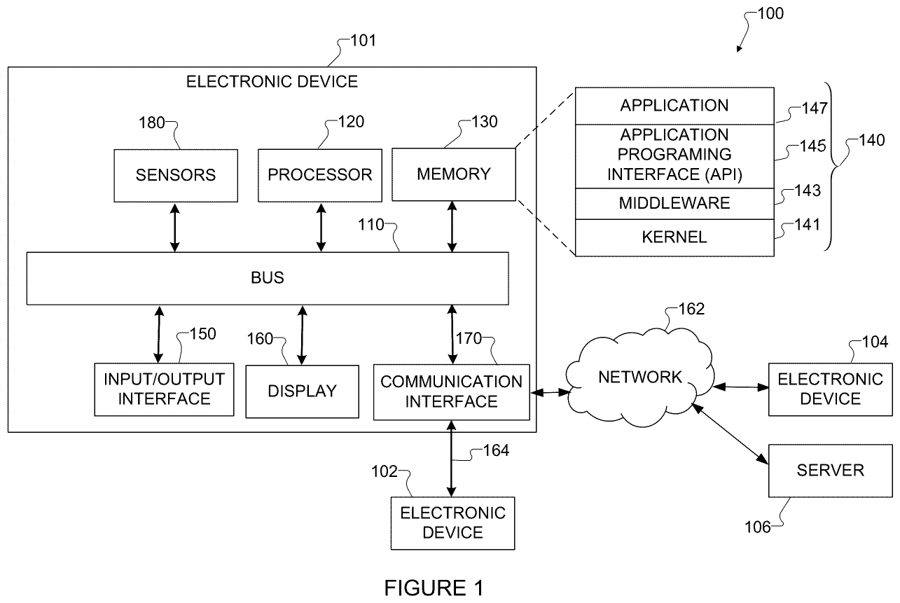

FIGS. 1 through 14, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As discussed above, extended reality (XR) is an umbrella term encompassing augmented reality (AR), virtual reality (VR), and mixed reality (MR). In the domain of XR, the user's experience is significantly enriched by the user's ability to interact with and manipulate virtual objects or software components, often referred to as “widgets.” These widgets, such as virtual buttons, sliders, dials, or other control elements, form one method for user interaction within the XR environment.

Current methods for placing and manipulating widgets in the XR space do exist; however, most of these methods are limited in their flexibility and intuitiveness, often resulting in a sub-optimal and frustrating user experience. For example, in some current methods, widgets are often pre-positioned in the XR space, giving the user little to no control over their placement or organization. This static arrangement lacks flexibility and adaptability, impeding the user's ability to customize their environment according to their preferences or needs.

Moreover, these methods often lack a practical mechanism for grouping related widgets together. Grouping mechanisms can simplify the interface, improve user experience by maintaining an organized environment, and provide easier access to related functions. The few current methods for widget grouping are often manual, cumbersome, and unintuitive, leaving much to be desired in terms of case and efficiency of interaction.

Additionally, current methods typically do not support easy addition or removal of widgets. In most cases, adding a new widget requires a complex series of user inputs or specific commands, leading to a steeper learning curve and hindrance to the user experience.

This disclosure provides various techniques for adding, placing, and grouping widgets in XR applications. As described in more detail below, the disclosed embodiments provide more intuitive, adaptable, and user-friendly techniques of adding, placing, and grouping widgets in XR space, thus enhancing the overall interaction and user experience in the XR environment.

Note that while some of the embodiments discussed below are described in the context of use in consumer electronic devices (such as head mounted displays), this is merely one example. It will be understood that the principles of this disclosure may be implemented in any number of other suitable contexts and may use any suitable devices.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described in more detail below, the processor 120 may perform one or more operations for adding, placing, and grouping widgets in XR applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions for adding, placing, and grouping widgets in XR applications as discussed below. These functions can be performed by a single application or by multiple applications that each carry out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an AR wearable device, such as a headset with a display panel or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform one or more operations to support techniques for adding, placing, and grouping widgets in XR applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

### Grid Layout

As described in greater detail below, widgets can be added, placed, or grouped according to a virtual grid that is rendered on a virtual board on the XR display of the HMD. The layout of the virtual grid can be determined automatically, or can be determined based at least in part on a user preference for the layout. A procedure for an automatic grid layout will now be discussed.

In some embodiments, the grid layout can be automatically determined and rendered in the user's XR space. In some embodiments, the virtual board on which the grid is shown is based on a surface of a real-world object, such as a table. For example, assume that a rectangular table is present in the XR view of the HMD. The table surface can be detected from the depth images collected by the world-facing cameras on the HMD. The images can be processed for plane detection, and edges of the horizontal plane of the table surface can be determined. In some embodiments, the plane can be detected by analyzing the depth images and checking for textures and patterns on wall and table surfaces. The edges of the table or similar furniture in front of the user can also be determined with depth data by looking for points aligned at the same level.

From this horizontal plane, a virtual rectangle can be rendered in 3D space as a board upon which the grid will be shown. In some embodiments, the rectangular board can appear semi-transparent or opaque in the HMD display. Additional vertically-oriented virtual rectangles can be formed above and/or below the table rectangle. In some embodiments, these additional rectangles are aligned with and start at left and right edges of the table rectangle, and can go up to the detected ceiling plane and down to the detected floor plane. The ceiling and floor planes can be determined from plane detection processed from received images. The lower end of the vertical rectangles can be aligned to the table height or could be slightly offset to be above the table surface.

Information about the rectangles that are aligned horizontally and vertically to the table can be passed from the system to the application, where the grid structure is rendered to matching the size of the table rectangle. The grid is formed of multiple square or rectangular cells arranged in a grid pattern. The size of each cell for the grid is fixed so that the grid dimensions can be based on the number of cells that can fit in the virtual rectangles. In some embodiments, the grid areas can be aligned on the detected rectangles.

The vertical grid areas aligned on the left and right sides of the table can be slightly tilted towards the user, so that the grid cells appear to face the user instead of being perpendicular to the horizontal grid area of the table. This tilted appearance can make it easier for interactions with the user.

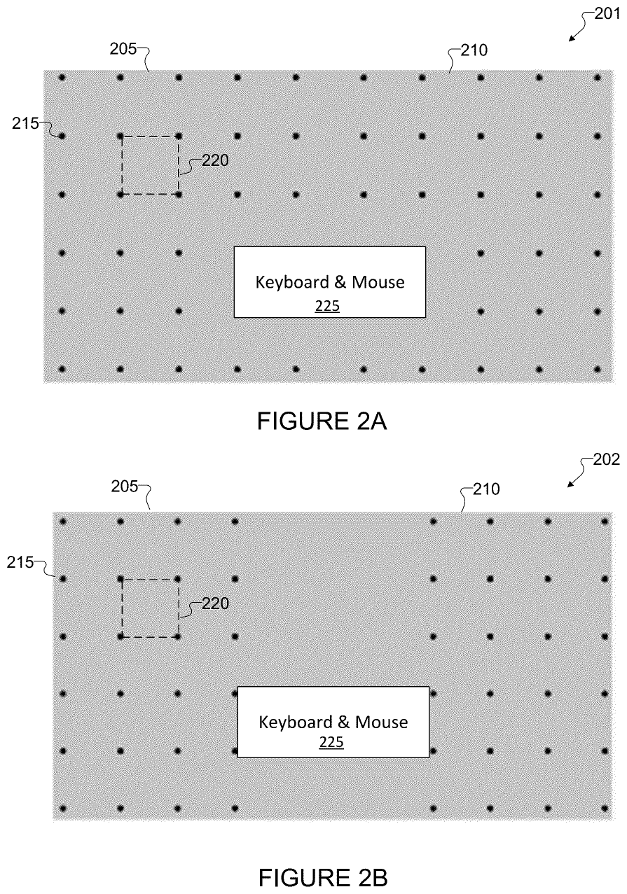

FIGS. 2A and 2B illustrate example XR views 201 and 202 showing virtual boards and virtual grids according to this disclosure. As shown in FIGS. 2A and 2B, the XR views 201 and 202 display a virtual board 205 that is superimposed over a real-world table surface 210. The boundaries of the virtual board 205 substantially align with the edges of the table surface 210. A grid structure 215 comprising multiple square cells 220 is rendered on the virtual board 205.

In some embodiments, the grid structure 215 can be adjusted for placement of virtual objects (such as widgets) that is convenient for the user, while also taking into account any real-world and virtual objects that are also present. For example, real-world objects that appear within the virtual rectangles can be cut out of the grid areas to avoid overlapping. In FIGS. 2A and 2B, a real-world keyboard and mouse 225 occupy a space on the table surface 210.

In one aspect of operation, depth images collected from the world-facing cameras on HMD can be processed for object detection to draw a bounding box around the keyboard and mouse 225 on the table surface 210. The keyboard and mouse 225 can be identified using object recognition and labelled accordingly so that the keyboard and mouse 225 can be grouped together in the same bounding box. The system can use the edges of the bounding box to determine an unusable location so the user won't be able to place widgets on top of the keyboard and mouse 225. The system can then align the grid areas around the unusable location starting with cells being aligned from the edges of the cutout and moving outwards. For example, in FIG. 2A, the area of the keyboard and mouse 225 is marked as an unusable location. The grid structure 215 is then aligned around the bounding box for the keyboard and mouse 225. In FIG. 2B, the entire vertical region associated with the keyboard and mouse 225 is marked as an unusable location. The grid structure 215 is then aligned on the left and right sides of the bounding box for the keyboard and mouse 225. In some embodiments, there could be other real-world objects the table surface 210 (such as a coffee mug) that could be detected to occupy specific grid cells 220. Such objects can also be marked as unusable for widget placement.

In addition to (or instead of) real-world objects appearing on horizontally oriented grids (such as the keyboard and mouse 225), there could be some real-world objects that could overlap with one or more vertical grids that are formed and aligned with the horizontal grid (such as a lamp next to the table surface 210). In such cases, the vertical grid planes also may need to be realigned or moved accordingly so the grid does not overlap with these objects when handling widget placement.

As described earlier, the vertical grid areas can start from the left and right edges of the grid area of the table rectangle and form upwards towards the ceiling plane. From the depth images acquired from the front facing cameras, the system could check if any real world object is intersecting with the vertical rectangles. Once intersection is detected, the vertical rectangles can be moved outwards (away from the table grid but still aligned to the edges) until no intersection is detected. Moving these vertical grid areas outwards could have a maximum limit for distance to avoid having them move too far away from the user and still be usable for widget interactions. If the maximum distance has been reached and there is still an intersection detected, the grid area could be adjusted to the distance with minimum intersection area, and the intersection area could be marked as unusable. The system can keep track of the intersection area while moving it along the axis away from the table grid to determine the minimum intersection. In this case, virtual widgets will not be allowed to be placed on the intersection area (which can be indicated or marked as an unusable area). If the minimum intersection area takes up more than 50% of the vertical grid area, it might not be useful for virtual widget placement and interactions. In this case, the system could remove this vertical grid area and only render those vertical grid areas that fit the aforementioned criteria.

As discussed above, the layout of the virtual grid can be determined automatically. Additionally or alternatively, the layout of the grid can be determined according to a user preference for the layout. For example, in some embodiments, the user can define areas for grid locations on horizontal surfaces and wall surfaces by using hand gestures or controller input by dragging rectangles around the spaces or drawing around surfaces.

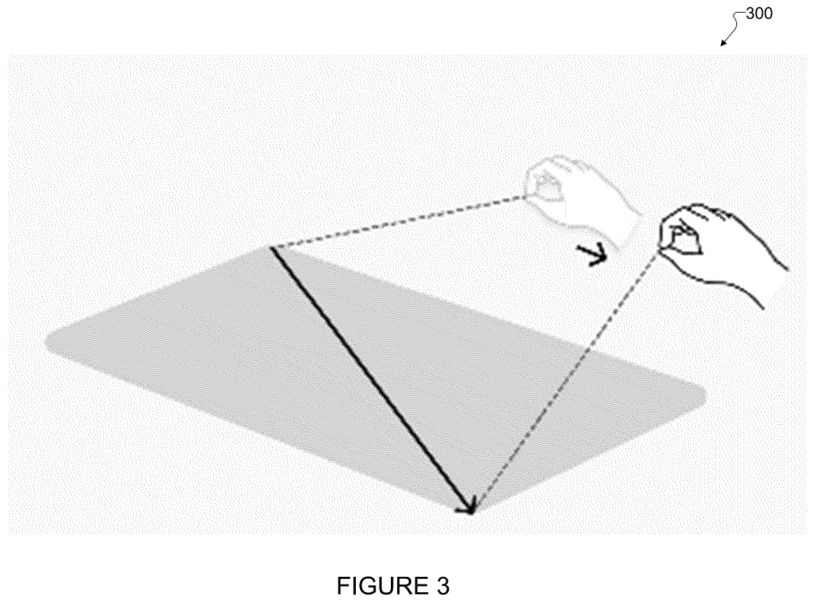

FIG. 3 illustrates an example technique 300 for a user to define a grid layout according to this disclosure. As shown in FIG. 3, the user can use a pinch and drag gesture to draw a rectangle on a horizontal surface for grid layout. In the pinch and drag, the user makes a pinch gesture while pointing at a location in user space. The user then holds the gesture while moving to the other location at the opposite end point of the rectangle, and then releasing the pinch gesture to complete the action. A rectangle is rendered and scaled as the user moves from the start to end point during this interaction.

In some embodiments, the rectangle could also be aligned to one or more surfaces detected in the user space with plane detection based on depth images collected by the HMD world-facing cameras. For example, when the user performs an interaction to draw a rectangle over the table surface, the user can hover the user's hand over the table surface pointing to the corner of the table, and the rectangle can be rendered on top of the plane detected. After drawing the rectangle, the user can choose to move or scale the rectangle if needed to make any adjustments on the desk or wall surface. This same interaction can also be achieved using a controller input, such as by pressing and holding a button (or other trigger) to draw rectangles, while moving between start and end points.

In some embodiments, a user could define multiple grid layouts or custom layouts, which could be saved on a server, the local device storage, or another storage location. The layouts could be synchronized to the device for later access by the user. The stored information can include the table rectangle coordinates in 3D space, the relative position and angles of the vertical rectangles, any additional custom rectangles the user might have added, and pass-through cutouts information, if that has been used in any of the layouts. In some embodiments, the saved layouts can be accessed from a system menu or a shortcut on a hand or controller menu.

When the user is positioned in front of the table and chooses a layout from the previously saved options, the grid areas can align to the table and wall surfaces based on the rectangles formed with planes detected from depth images. The edges of the table surface can determine the dimensions for the rectangle, and the vertical rectangles can be aligned to the left and right of the table rectangle. Once the rectangles are aligned, the grid areas can be rendered to fit in the rectangle areas. The grid areas can be center aligned. If there is a pass-through cutout, the grid areas can be aligned around the edges of the pass-through cutout for that region.

If the user is in a location where the system does not detect a table surface, the grid areas will be rendered at a default position with the horizontal grid area at a height from the detected ground that resembles a standard table height and the rest of the vertical rectangles can be aligned to the horizontal grid area rectangle.

Turning again to FIGS. 2A and 2B, the dimensions of the grid structure 215 are determined based on the rectangular virtual board 205 formed by planes detected in the user space using the depth images from cameras. The table surface 210 and its edges detected from depth data can form the sides of the virtual board 205 for the horizontal grid areas. Any vertical grids can be aligned on side of the virtual board 205 and take the length of the edge of table surface 210. The height of any vertical grids can be up to the ceiling, which can be detected as a plane with depth sensing.

The cells 220 comprising the grid structure 215 are fixed size, and the number of cells 220 forming the grid structure can be determined by the length and width of the grid structure 215. The grid structure 215 can be center aligned to the rectangular table surface 210. Any vertical grids can be aligned on the left and right of the table surface. The left and right vertical grids can be tilted slightly to face towards the user for easier interactions.

As shown in FIGS. 2A and 2B, the corners of the cell 220 can be rendered as dots. Additionally or alternatively, the cells 220 can have lines on the edges. In some embodiments, the grid structure 215 can be configured to fade in only when the user is interacting (e.g., adding or moving widgets on the grid areas). When the interaction is complete, the grid structure 215 can fade out so the user can focus on the pass-through or immersive environment.

### Adding Widghets

Once a grid is defined and rendered in the XR space, the user can add a widget to the grid. The user can select the widget to add from a widget library panel that is rendered in the XR space. In some embodiments, the widget library panel includes a menu system with 2D widget icons that are rendered in a scrollable array. From the widget library panel, the user can select and drag a widget or use the add button to automatically add the widget to the user space. In some embodiments, the widget library panel can be accessed from a system menu, where the user can choose to open it as needed and close when done, since the panel should be displayed in front of the user to add widgets.

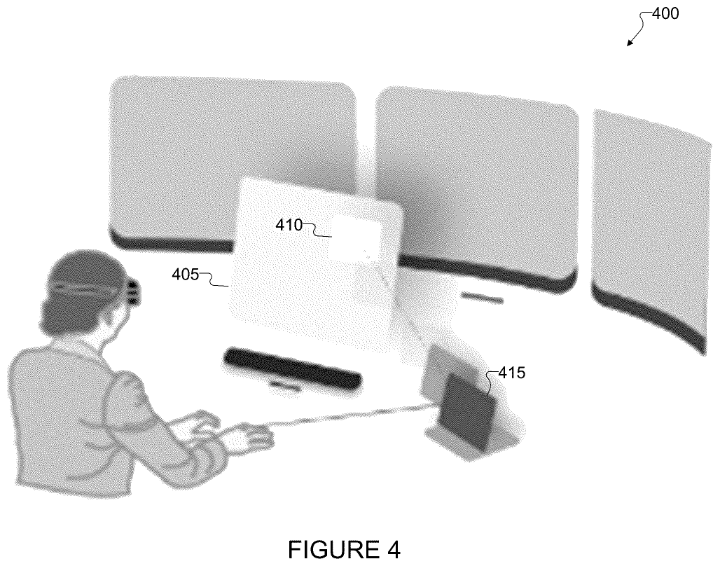

FIG. 4 illustrates an example XR space 400 in which a widget library panel can be displayed according to this disclosure. As shown in FIG. 4, the XR space 400 includes a widget library panel 405 that is rendered in front of the user. The panel 405 includes one or more widget options 410 that represent widgets that can be added to the user's workspace. In some embodiments, the panel 405 can be centered on a desk with a slight offset from a desk surface rectangle 415. The desk surface rectangle 415 has been previously determined with plane detection, and can be covered in a grid layout section, such as shown in FIGS. 2A and 2B. The panel 405 can be slightly tilted where the upper edge is away from the user (similar to a laptop screen) to make it easier for the user to view the widget options 410 rendered and interact while adding and dragging widgets out of the panel 405.

In some embodiments, the user can hold the panel 405 with hand gestures to move the panel 405 around. For example, the user can use a pinch and hold gesture while touching the panel 405; the system registers a hit point and the pinch and hold gesture. Then the user can move the user's hand where the panel 405 will be aligned with the virtual hand being rendered following it to the new location. When the user releases the pinch gesture, the panel 405 aligns again on the desk surface rectangle 415 with an offset and orients itself towards the user using the same tilt of the upper edge away from the user. The orientation towards the user is based on the HMD location in virtual space obtaining the real-time position of the user.

In some embodiments, a user can move a widget to a desired location or automatically add the widget in the next empty location by using the add function (similar to how a user can add icons or widgets on a smartphone). In XR space, the widgets can be added and moved directly with direct contact of a virtual hand or indirectly using ray casting and remote handling with hand gestures. There may not be haptic feedback as the user is moving the hand freely in the air during interaction, thus visual and/or audio feedback can be helpful in showing progression in interaction.

To select a widget, a user can use a pinch hand gesture in XR space. In addition to a pinch gesture that is registered by the system, the system can also check a hit point on a ray cast when the user is pointing at the widget or collision with virtual hand with direct interaction.

To move a widget to a desired location, the user can use a hand movement registered with hand tracking in XR space, where the virtual hand corresponds to the real hand movement of the user. The widget can move along the virtual hand if held in direct interaction, or can move smoothly in space following the hand motion in indirect interaction. To release the widget after a move, the use can use a pinch release gesture in XR space.

In some embodiments, a widget can be added by manually placing the widget from a widget library. For example, the system can detect that the user is pointing at the panel 405 with hand tracking, and can check for a hit point. If the hit point is on a widget icon and the user switches to a pinch gesture, the system can check which widget has been selected based on the hit point and if the user is still holding the pinch gesture.

While holding the pinch gesture, if the user starts moving the user's hand out of the panel 405, the widget 3D object starts fading in and appears from the 2D icon and starts moving along with the hand movement. The widget then continues moving in space and glides over the grid surface as the user is holding the pinch gesture while moving it to a grid location. When the user finds a grid location to place the widget, the user can release the pinch. The system registers a pinch release gesture with hand tracking and snaps the widget to that grid location. The intended grid location is highlighted while the user is dragging it in space, so that the user knows where the widget will be placed. The highlight function is explained in greater detail below.

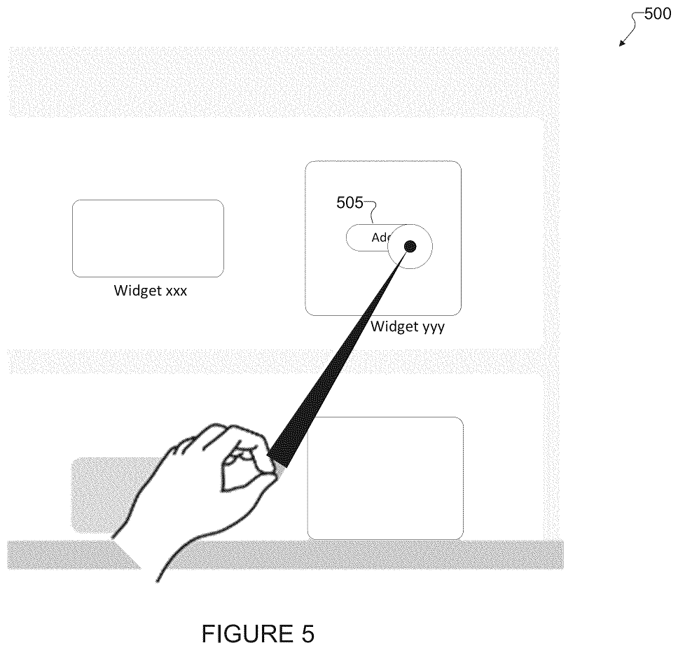

In some embodiments, a widget can be added by automatically placing the widget from a widget library. For example, the system can detect that the user is pointing at the panel 405 with hand tracking and can check for a hit point with ray cast. If the hit point is on an ‘Add’ button on the widget and the user has switched to a pinch gesture, the system checks if the user releases the pinch gesture and then calls the add function to add the selected widget to an empty grid location. FIG. 5 illustrates an example image XR space 500 in which the user selects an ‘Add’ button 505 to add a widget, according to this disclosure. Once the ‘Add’ button 505 is selected, a 3D widget is spawned from the 2D widget icon that fades in and appears from the panel 405 and smoothly moves to an empty grid location. The empty grid location can be found in a few ways, as explained in the following section.

### Finding Empty Cells for Automatically Adding Widgets

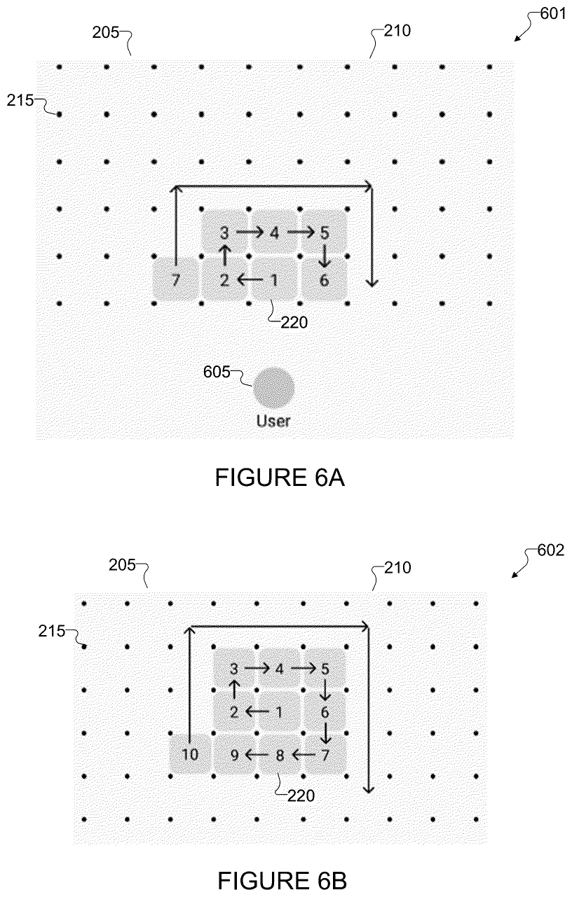

When the user chooses to automatically add a widget, the system searches for an empty cell in the grid structure 215. In some embodiments, there may be more than one grid structure 215 in a layout, and the empty cell search can start with the horizontal grid layout that is aligned with the table surface 210 first. There are multiple ways to search for empty cell locations. These will now be described in conjunction with FIGS. 6A through 6C.

FIGS. 6A through 6C illustrate various techniques 601-603 for searching for empty cell locations according to this disclosure. As shown in FIG. 6A, the technique 601 includes the system searching by starting at a grid cell 220 closest to the user 605 in the grid structure 215. This allows newly spawned widgets to be in the user's focus when placed closest to the user on the grid. If the center cell 220 (labeled ‘1’) is occupied, the search function will look for the neighboring grid cells 220, starting with the cell 220 to the left (‘2’), then left-top (‘3’), top (‘4’), right-top (‘5’), and then right (‘6’). This search of neighboring cells 220 continues until an empty cell 220 is found on the current grid structure 215. If all cells 220 are occupied on the current grid structure 215, the system then searches within any vertical grid structures 215, such as to the left or right of the table surface 210. If all grid cells 220 on all grid structures 215 are occupied, the user will be prompted and the widget will not be added in the user space.

As shown in FIG. 6B, the technique 602 includes the system starting the search for empty grid cells 220 in the center of the grid structure 215 of the table surface 210. If that cell 220 (labeled ‘1’) is occupied, the search function will search in a clockwise direction, starting with the cell 220 to the left (‘2’), then left-top (‘3’), top (‘4’), right-top (‘5’), right (‘6’), right-bottom (‘7’), bottom (‘8’), and left-bottom (‘9’). This continues in an outward direction until an empty cell 220 is found on the current grid structure 215. If all cells 220 are occupied on the current grid structure 215, the system then searches within any vertical grid structures 215, such as to the left or right of the table surface 210. If all grid cells 220 on all grid structures 215 are occupied, the user will be prompted and the widget will not be added in the user space.

As shown in FIG. 6C, the technique 603 includes the system starting on the edges of the grid structure 215 of the table surface 210. In some cases, the center area of the grid structure 215 may be occupied with one or more objects, such as a keyboard and mouse in a work setup. In such cases, adding widgets on the edges of the grid structure 215 can be better. Here, the empty cell search begins on the left edge of the grid structure 215 starting from closer to the user 605 and moving away from the user 605. If the left edge is already filled with widgets or other obstacles, the search continue on the right edge, and then comes back to the left on the next empty column moving inwards. This continues until all cells 220 are searched. If all cells 220 are occupied on the current grid structure 215, the system then searches within any vertical grid structures 215, such as to the left or right of the table surface 210. If all grid cells 220 on all grid structures 215 are occupied, the user will be prompted and the widget will not be added in the user space.

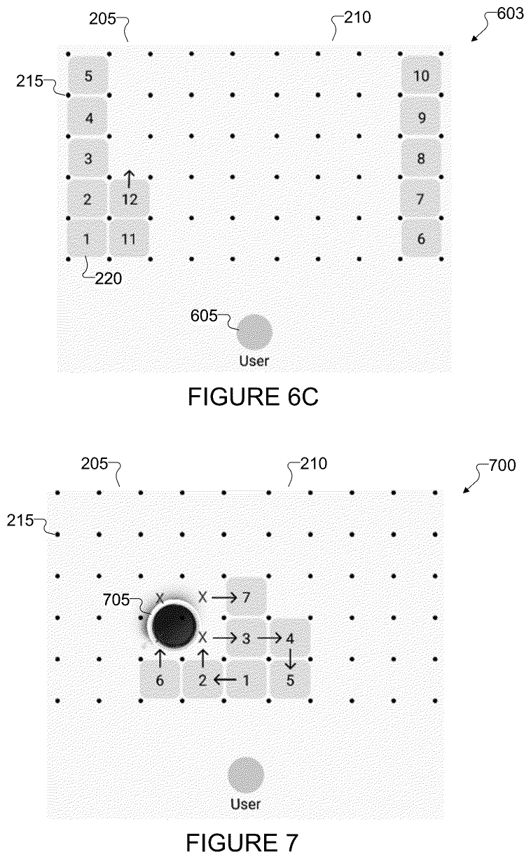

While using the add function to automatically add widgets on the grid structure 215, if there are real world objects on the table surface 210, the search function can ignore those grid cells 220 when finding the next empty location. For example, FIG. 7 illustrates an example XR view 700 in which the table surface 210 includes a real world object, according to this disclosure. As shown in FIG. 7, the real world object 705 can be a coffee cup on the table surface 210. During the search, the system can determine which grid cells 220 are occupied by the real world object 705 using object detection and processing the depth images captured from world facing cameras. The occupied cells 220 can be marked as occupied, such as with an ‘X’. During the search (such as by using the technique 601), the grid cells 220 occupied by the real world object 705 are ignored and the search continue to the next grid cell 220 in sequence.

If the real world object 705 is picked up, the grid cells 220 occupied by the real world object 705 can then be released so that those cells 220 can be used for widget placement. Additionally, if the real world object 705 is moved to a new location within the grid structure 215, that new location should be marked as occupied and unusable for virtual object interaction.

Images and video captured from the world facing cameras can be used in object detection to determine the current placement of objects on the grid structure 215. The detection and change in position can be coupled with hand tracking, such that if the user picks up a real world object, the system can perform another scan on the grid structure 215 to check if there was any change from the objects detected previously. A user's “picking up” action can be registered with a gesture along with the position of the hand with respect to the grid structure 215 that is aligned with the table surface 210. When the object is placed in a location, the object detection scan marks those grid cells 220 as occupied so that new widgets will not be added to these locations.

In some embodiments, when a widget is selected from the panel 405 to add to the user space, the widget can pop out of the 2D widget icon and be displayed as a 3D object that is now in the user's control to move around and place. The transition from 2D to 3D can be smooth, such that it appears like the 2D widget icon scales in depth to start adding details and appears on top of the panel 405. The 3D object for transition can be loaded from a database based on which widget has been selected.

When the object is instantiated in virtual space, it may first appear faded (e.g., textures are not rendered initially) and can be scaled to 0 for thickness. The object then starts fading in while increasing in thickness to get to its actual size while moving out to appear floating on the surface of the panel 405. Shadows can be rendered as the 3D object emerges out of the panel 405, thus giving it more definition during this transition.

### Moving Widgets

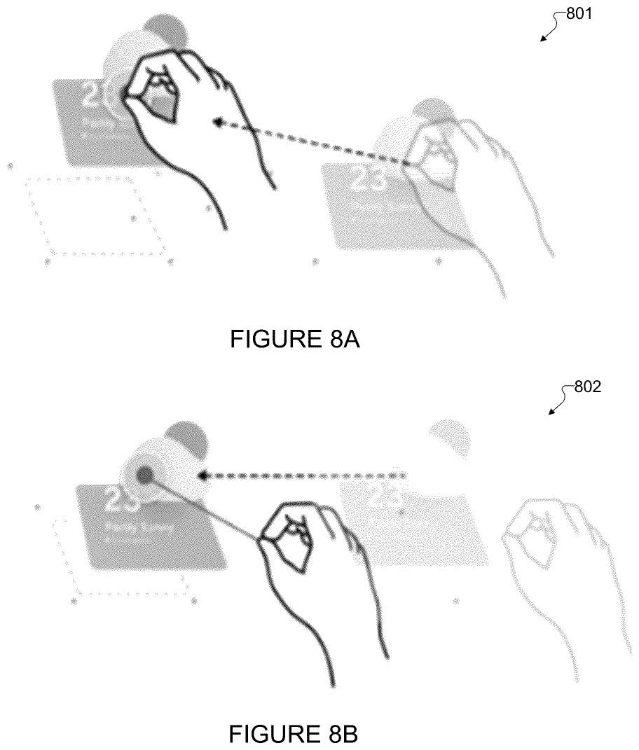

In addition to adding a widget to the grid structure 215, a user can move a widget around the grid or between grids. In some embodiments, widgets can be moved either near-field (e.g., under 10 cm distance) or far-field (e.g., greater than 10 cm distance). FIGS. 8A and 8B illustrate example techniques 801 and 802 for moving widgets according to this disclosure. As shown in FIG. 8A, the technique 801 is a near-field move, where the user's hand or a controller directly accesses the widget object. As shown in FIG. 8B, the technique 802 is a far-field move, where interaction is supported by visual extension (such as a ray cast).

With hand tracking the system detects the location where the user moves and points in space. A ray cast from the user's hand can be checked to see if it collides with a widget when the user is pointing at it. While the user is pointing the hand towards a widget and uses a pinch gesture, the system checks if the user is holding the pinch gesture for at least a threshold time duration. If the user releases the pinch immediately, the system checks if the hit point on the widget is on a specific button or interactive element on the widget to complete that action. If the user holds the pinch gesture and starts moving the hand, the system recognizes the movement if it crosses a specific threshold. Also, the system recognizes a continuing pinch gesture along with movement that triggers the dragging function. The widget starts moving from the current location following the hand movement.

If the widget is picked up by the user with direct interaction, the widget moves along with the virtual hand in the pinch gesture rendered with hand tracking. Adding a widget is complete when the user releases the pinch at a desired grid cell 220. In some embodiments, the widget can snap on that location.

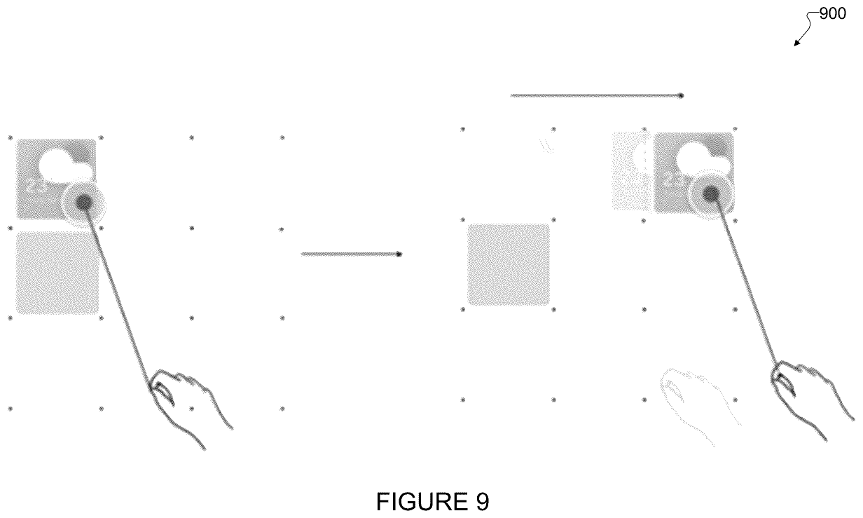

FIG. 9 illustrates an example 900 of the use of constraints on a grid surface when moving a widget according to this disclosure. As shown in FIG. 9, if the widget is remotely held, it will start gliding over the grid surface following the hand movement. The widget movement may appear as if it is constrained on the grid surface with a slight offset. When the user releases the widget during remote handling or indirect interaction, the widget moves smoothly and snaps to the nearest grid location where the pinch is released. In some embodiments, the grids are hidden by default, and only become visible while the user is placing or moving the widgets.

### Dynamic Grid

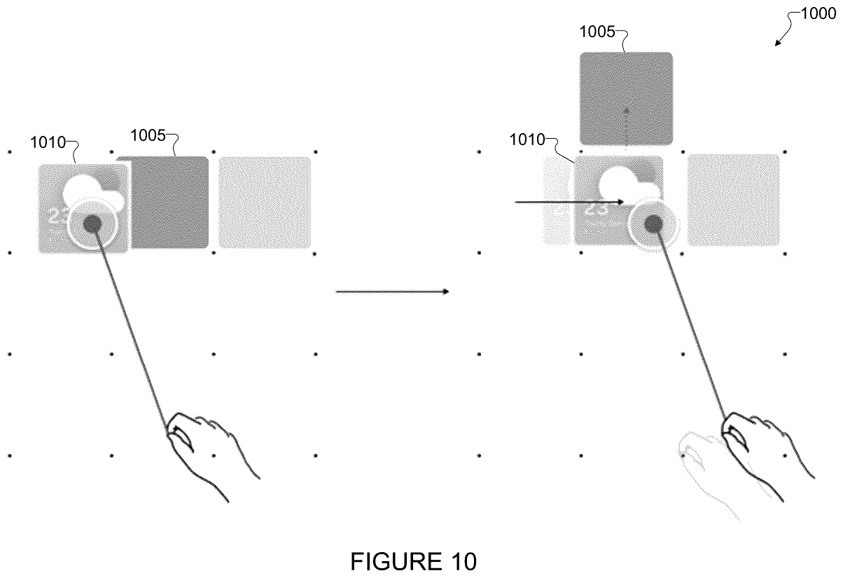

In some embodiments, when a widget is placed on a grid cell 220 that is occupied by an existing widget, the grid structure 215 can update the configuration by moving the existing widget to a neighboring empty cell 220. FIG. 10 illustrates an example 1000 of moving an existing widget 1005 to place a new widget 1010, according to this disclosure. When moving the existing widget 1005 to the neighboring empty cell, the system can detect any existing virtual objects or widgets placed on the grid structure 215, and can also detect any real world objects that occupy grid cells 220 (which become unusable for placement of virtual objects).

When the user moves a widget to a new grid location, there may be one or more existing widgets that occupy the grid cells 220 of the new location. In such a case, the system can relocating the existing widget(s) to new grid cells 220. In some embodiments, a highlight projection shows the grid cell 220 in a different color, which indicates that the cell 220 is occupied. While moving the widget, the system can determine where the user is pointing at with hand tracking and looking at the hit point on the grid cell 220 to check on the next intended location and if it matches to the existing widget location. If the user chooses to place a widget in this location by releasing the pinch, the system can search for the next empty grid location relative to the existing widget and move that widget to that location. The search function can look for an empty cell starting from left, top, right, or bottom of the widget grid cell. This search continues recursively until an empty grid cell is found to move the existing widget. This process can be applied to all the widgets by moving them to the next empty grid cells. If no empty cell is found, the new widget will not be added and the user can be prompted.

If the existing widget is larger than a 1×1 grid cell 220 and is close to the edge of the grid structure 215, the widget needs to offset while being placed so that the widget does not extend outside the boundaries of the grid structure 215. The offset can be calculated based on the size of the existing widget being moved and the space available to move in the new location. If the search function does not find enough space to move at this location, the search function will look for the next empty grid cell location.

If the new widget is of a different size than the existing widget (e.g., if the number or arrangement of grid cells 220 occupied by the widgets are different), the occupied grid cells 220 are updated accordingly when widgets are moved. When the existing widget is moved to a new location, the new location will occupy the same number of grid cells 220 in the new location, while the new widget could occupy more or fewer grid cells 220 in the location. For example, if the existing widget occupies 2×1 grid cells 220 and a new widget being moved to this location is 1×1, the existing widget will release 2 grid cells 220 (2×1) and move to a new location that occupies 2 empty grid cells 220, while the new widget will only occupy 1 grid cell 220 from the released cells 220.

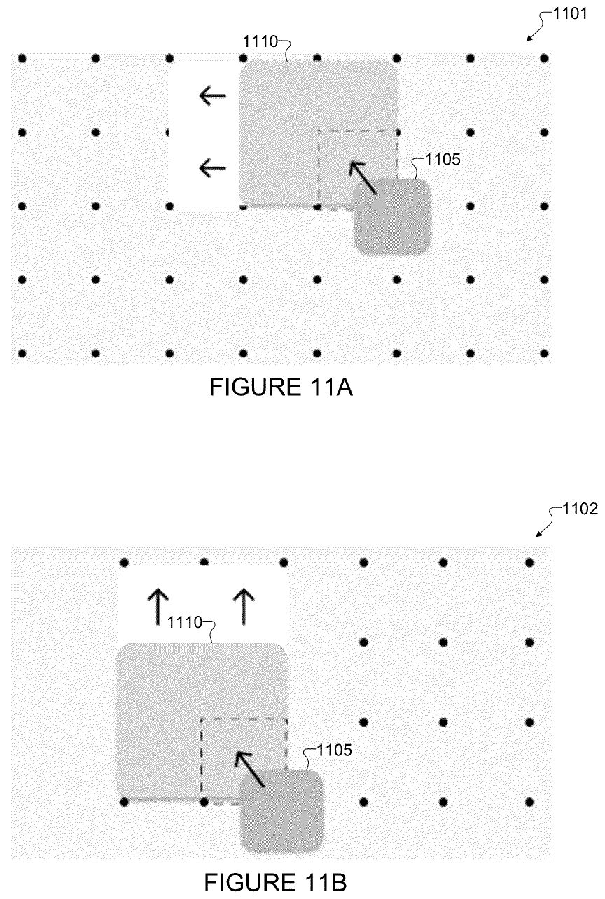

FIGS. 11A and 11B illustrate examples 1101 and 1102 for handling widgets of different sizes according to this disclosure. As shown in FIGS. 11A and 11B, a 1×1 widget 1105 is moving to a location currently occupied by a 2×2 widget 1110. In FIG. 11A, the existing widget 1110 is moved to an empty location to the left. In FIG. 11B, the existing widget 1110 is at the left edge, so it cannot move to the left. Instead, the existing widget 1110 is moved up.

If there are any real world objects occupying any grid cells 220 in the grid structure 215, those need to be considered as well while handling overlapping of widgets. During a search for an empty cell 220, if the cells 220 around the existing widgets are occupied by a real world object (e.g., a keyboard, a coffee cup, or the like), the system can mark those cells 220 as unusable and continue searching for the next empty cell 220. The existing widgets can then be moved around the real world objects, while avoiding overlapping on both virtual and physical objects in the user space. The real world objects can be determined with the depth images acquired by front facing cameras and processed for object detection as discussed above.

### Highlight Projections

As discussed above, highlight projections can be used to highlight grid cells 220, such as by showing grid cells 220 in a different color. This can be used, for example, to indicate that a cell 220 is occupied. In some embodiments, highlight projections can be updated to have smooth motion to follow widgets to a next intended snap location, similar to a mobile widget highlight. While moving widgets, a highlight appears that indicates where the widget is about to be placed. The highlight is rendered based on where the user is moving and pointing the widget or could be based on gaze focus to lock the next placement location.

When an existing object (such as a widget) is detected in a grid cell 220, the highlight projection could indicate it is occupied. The projection could be rendered in a different color on this grid cell 220. When a real world object disposed in user space (such as a cup or keyboard on the user's table) is detected, those grid cells 220 can be highlighted as unusable grid cells 220 for placement. Similar to virtual objects, these could also be rendered in a different color or with a ‘X’.

In some embodiments, hand ray casting can be used for highlight projection. When moving a widget around in 3D space, the highlight can be projected starting from the hand position using the hand orientation to determine the intended grid location for next placement. The user can move the hand around on the intended grid area where the widget is in hand or hovering over the surface while the grid highlight snaps to the location following the movement.

In some embodiments, gaze focus can be used for highlight projection. For example, instead of using the hand location and orientation, the user can just look at a grid location that will quickly highlight the intended location where the user can release the widget that will snap to that location. This reduces the effort for user to move around the hand on grid surfaces, resulting in less fatigue if used for longer period of time.

### Widget Orientation

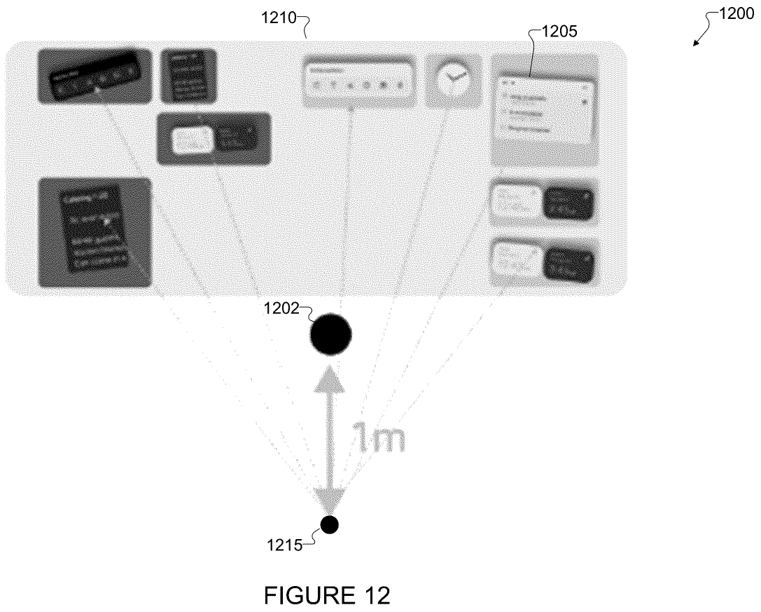

FIG. 12 illustrates an example XR view 1200 showing widget orientation on a surface according to this disclosure. As shown in FIG. 12, when a user 1202 places a widget 1205 so that it shows on a table surface 1210, the widget 1205 can be oriented (e.g., rotated) towards the user 1202. When the user 1202 moves the widget 1205, the widget 1205 can re-orient itself towards the user 1202 depending on the location. Depending on implementation, there can be variable degrees of widget orientation towards the user 1202. Testing shows that a comfortable orientation is where the widgets 1205 are oriented towards a point 1215 slightly behind (e.g., approximately 1 meter behind) the user 1202.

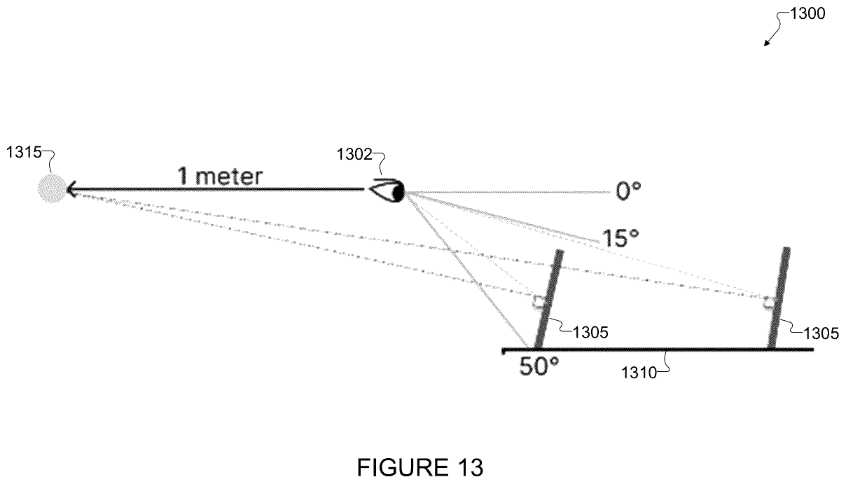

In some embodiments, the widgets can be displayed as appearing tilted relative to a table surface. FIG. 13 illustrates an example 1300 of widget tilt according to this disclosure. As shown in FIG. 13, widgets 1305 can be tilted slightly backward relative to the table surface 1310 and the user 1302. The tilt angle can be based on how far each widget 1305 is from the user 1302 on the table surface 1310. That is, the tilt angle can be larger if the widget 1305 is closer to the user 1302.

In some embodiments, the tilt angle can be calculated based on a 3D point in space that is offset from the user HMD position. For example, the widgets 1305 can be tilted such that they are looking back at a point 1315 that is 1 meter behind the user 1302. Testing has shown that comfortable UI placement when showing UI for a long time is between 15° and 50°. The widgets 1305 can be oriented such that the ray formed by the 3D point 1315 and the widget location is normal to the widget panel surface.

In some embodiments, this tilt technique is applied only to surface type widgets. Wall widgets can be aligned to the wall grid area, and the angle can be based on the orientation of the wall grid area.

In some embodiments, a widget can be added by using both a user's gaze and hand gestures. That is, instead of using a hand gesture or controller pointing to point at the library options to select a widget, the user can gaze upon one of the widget options; this results in highlighting a widget that the user would like to spawn and place in user space. The user's gaze direction can be determined with eye tracking cameras or sensors that can check an intersection point in 3D space. The eye tracking sensors, when detecting the user's eye movement, could form a combined gaze ray for the direction the user is looking at. The gaze direction ray may intersect objects in 3D space moving outwards from the user's eye position. The system looks for this hit point to determine if the point is on a widget icon on the panel; if so, the widget icon can be highlighted.

Once selected, the user can pinch or have a controller input and hold to move the widget that has been instantiated. This reduces the effort on the user since the user does not have to move the hands as much to select a widget from the library. To automatically add a widget, the user can look at the ‘Add’ button on the widget library panel and then use a pinch gesture to quickly add the widget to the next empty location on the grid area. To manually add a widget, the user can look at the widget icon and use a pinch and drag gesture to manually move the widget to a desired grid location.

In some embodiments, a user's gaze focus can also be combined with voice input to select and complete the action. For example, the user's gaze focus can be used to select a widget from the library, and then the user can speak a voice command among pre-defined phrases like ‘Add to desk grid,’ which will automatically add the widget to that grid area finding an empty grid cell. The voice input could run through natural language processing (NLP) to process the user input phrases and break it down into keywords. The keywords can be matched with a dictionary that stores relevant words for the grid layout and details of virtual and real world objects detected in user space. This could be stored on a server that could be updated and accessed later in further sessions. This interaction is useful for accessibility scenarios where the user can have control over adding widgets without a hand or controller input.

Similarly, a voice command can take into account any information of real world objects in user space. For example, if the user wants a calendar widget to be moved to the real clock on his desk the user could speak the command ‘Add calendar widget next to my clock’. To enable this functionality, the system can detect and recognize real world objects and store information about the real world objects in a database. In operation, a user input phrase or command can be analyzed to check for keywords to determine if they match with any real world object(s) for context and what action needs to be taken. The search function can look for empty grid cells near the relevant real world object and place the widget that has been selected with the user's gaze focus.

In addition to adding widgets, user gaze can also be used for moving widgets. That is, widget placement can be updated and be more efficient if the user's gaze is used; this can reduce some effort of the user to interact with and move widgets to new locations. As discussed above, the user can focus on a grid location to indicate an intended location to place the widget while holding the widget with a pinch gesture and releasing when ready. The system can highlight the location in the user's focus. By using gaze, the user does not have to move a hand to point to existing widget locations or library options to select a widget and then move again to a desired grid location since these locations will be highlighted with the user's gaze focus. In some embodiments, the grid are hidden by default, and only become visible while the user is placing or moving a widget. If using a controller, the gaze focus to select an intended location can be followed with a button input from the controller.

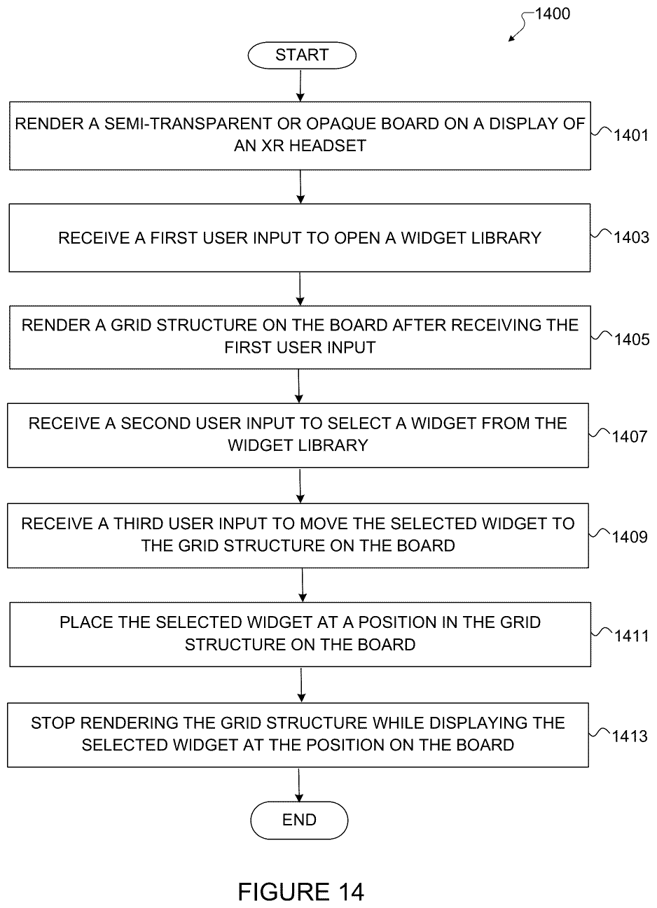

FIG. 14 illustrates an example method 1400 for adding widgets in an XR application according to this disclosure. For case of explanation, the method 1400 shown in FIG. 14 is described as being performed using the electronic device 101 shown in FIG. 1 and the widget techniques shown in FIGS. 2A through 13. However, the method 1400 shown in FIG. 14 could be used with any other suitable device(s) or system(s) and could be used to perform any other suitable process(es).

As shown in FIG. 14, at step 1401, a semi-transparent or opaque board is rendered on a display of an XR headset (such as an HMD) in communication with an electronic device, such that the board does not overlap with at least one real-world object recognized by the electronic device. This could include, for example, the electronic device 101 rendering a virtual board 205 superimposed over a real-world table surface 210, such as shown in FIGS. 2A and 2B.

At step 1403, a first user input is received to open a widget library. This could include, for example, the electronic device 101 receiving a user input to open the widget library panel 405, such as shown in FIG. 4.

At step 1405, a grid structure is rendered on the board after receiving the first user input. This could include, for example, the electronic device 101 rendering the grid structure 215 on the virtual board 205, such as shown in FIGS. 2A and 2B.

At step 1407, a second user input is received to select a widget from the widget library. This could include, for example, the electronic device 101 receiving a user input to select one of the widget options 410 from the widget library panel 405, such as shown in FIG. 4.

At step 1409, a third user input is received to move the selected widget to the grid structure on the board. This could include, for example, the electronic device 101 receiving a user hand gesture to move the selected widget 410 to the grid structure 215.

At step 1411, the selected widget is placed at a position in the grid structure on the board. This could include, for example, the electronic device 101 automatically searching for an empty cell location, such as shown in FIGS. 6A through 6C, and placing the selected widget 410 in an empty cell 220.

At step 1413, the rendering of the grid structure is stopped while the selected widget is displayed at the position on the board, with an orientation determined based at least partly on a user's head position. This could include, for example, the electronic device 101 hiding the grid structure 215 and displaying the widget 410 in the cell 220, with an orientation determined such as shown in FIGS. 12 and 13.

Although FIG. 14 illustrates one example of a method 1400 for adding widgets in an XR application, various changes may be made to FIG. 14. For example, while shown as a series of steps, various steps in FIG. 14 could overlap, occur in parallel, occur in a different order, or occur any number of times (including zero times).

The disclosed embodiments provide a number of advantageous benefits. For instance, widgets placed on a grid structure and aligned and oriented towards the user, such as described herein, makes it easier for interaction and legibility. Automatically resizing widgets based on which grid structure they are placed and on distance ensures the readability of text on widgets at any location. Automatically rearranging existing widgets to avoid overlapping when new widgets are placed on the grid structure reduces the amount of effort by users to manually move several widgets. Highlight projections during placement ensure that the user is aware of the next intended location where the widget could be placed on the grid. Combining hand interaction with eye gaze reduces effort on the user while placing widgets. Combining eye gaze interaction with voice improves accessibility when hand interaction or controller input is not an option.

Note that the operations and functions shown in or described with respect to FIGS. 2A through 14 can be implemented in an electronic device 101, 102, 104, server 106, or other device(s) in any suitable manner. For example, in some embodiments, the operations and functions shown in or described with respect to FIGS. 2A through 14 can be implemented or supported using one or more software applications or other software instructions that are executed by the processor 120 of the electronic device 101, 102, 104, server 106, or other device(s). In other embodiments, at least some of the operations and functions shown in or described with respect to FIGS. 2A through 14 can be implemented or supported using dedicated hardware components. In general, the operations and functions shown in or described with respect to FIGS. 2A through 14 can be performed using any suitable hardware or any suitable combination of hardware and software/firmware instructions.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
rendering, by a processor, a semi-transparent or opaque board on a display of an extended reality (XR) headset in communication with the processor, such that the board does not overlap with at least one real-world object recognized by the processor;
receiving, by the processor, a first user input to open a widget library;
rendering, by the processor, a grid structure on the board after receiving the first user input;
receiving, by the processor, a second user input to select a widget from the widget library;
receiving, by the processor, a third user input to move the selected widget to the grid structure on the board;
placing, by the processor, the selected widget at a position in the grid structure on the board; and
stopping, by the processor, rendering the grid structure, while displaying the selected widget at the position on the board, with an orientation determined based at least partly on a user's head position.

2. The method of claim 1, wherein the grid structure includes a dot grid structure or a line grid structure.

3. The method of claim 1, wherein the second user input includes a pinch gesture, and the third user input includes a drag gesture while maintaining the pinch gesture.

4. The method of claim 1, wherein placing the selected widget at the position comprises moving one or more pre-existing widgets within the grid structure.

5. The method of claim 1, wherein placing the selected widget at the position comprises:
highlighting one or more candidate grid positions for the selected widget; and
visually indicating one or more locations occupied by one or more virtual or real-world objects recognized by the processor as obstacles.

6. The method of claim 1, wherein:
the second user input and the third user input comprise images of the user's eyes captured using an eye tracking camera coupled to the XR headset; and
the method further comprises:
detecting, based on the images from the eye tracking camera, that the user's eyes are focused on the selected widget.

7. The method of claim 1, wherein:
the second user input comprises images of the user's eyes captured using an eye tracking camera coupled to the XR headset;
the third user input comprises a voice input from the user; and
the method further comprises:
providing the voice input to a natural language processing module trained to identify keywords in the voice input including instructions to move the selected widget to the grid structure on the board.

8. The method of claim 7, wherein the keywords include a real-world object and a desired position for the widget relative to the real-world object.

9. An electronic device comprising:
at least one processing device configured to:
render a semi-transparent or opaque board on a display of an extended reality (XR) headset in communication with the at least one processing device, such that the board does not overlap with at least one real-world object recognized by the at least one processing device;
receive a first user input to open a widget library;
render a grid structure on the board after receiving the first user input;
receive a second user input to select a widget from the widget library;
receive a third user input to move the selected widget to the grid structure on the board;
place the selected widget at a position in the grid structure on the board; and
stop rendering the grid structure while displaying the selected widget at the position on the board, with an orientation determined based at least partly on a user's head position.

10. The electronic device of claim 9, wherein the grid structure includes a dot grid structure or a line grid structure.

11. The electronic device of claim 9, wherein the second user input includes a pinch gesture, and the third user input includes a drag gesture while maintaining the pinch gesture.

12. The electronic device of claim 9, wherein to place the selected widget at the position, the at least one processing device is configured to move one or more pre-existing widgets within the grid structure.

13. The electronic device of claim 9, wherein to place the selected widget at the position, the at least one processing device is configured to:
highlight one or more candidate grid positions for the selected widget; and
visually indicate one or more locations occupied by one or more virtual or real-world objects recognized by the at least one processing device as obstacles.

14. The electronic device of claim 9, wherein:
the second user input and the third user input comprise images of the user's eyes captured using an eye tracking camera coupled to the XR headset; and
the at least one processing device is further configured to detect, based on the images from the eye tracking camera, that the user's eyes are focused on the selected widget.

15. The electronic device of claim 9, wherein:
the second user input comprises images of the user's eyes captured using an eye tracking camera coupled to the XR headset;
the third user input comprises a voice input from the user; and
the at least one processing device is further configured to provide the voice input to a natural language processing module trained to identify keywords in the voice input including instructions to move the selected widget to the grid structure on the board.

16. The electronic device of claim 15, wherein the keywords include a real-world object and a desired position for the widget relative to the real-world object.

17. A non-transitory machine-readable medium containing instructions that when executed cause at least one processor of an electronic device to:
render a semi-transparent or opaque board on a display of an extended reality (XR) headset in communication with the at least one processor, such that the board does not overlap with at least one real-world object recognized by the at least one processor;
receive a first user input to open a widget library;
render a grid structure on the board after receiving the first user input;
receive a second user input to select a widget from the widget library;
receive a third user input to move the selected widget to the grid structure on the board;
place the selected widget at a position in the grid structure on the board; and
stop rendering the grid structure while displaying the selected widget at the position on the board, with an orientation determined based at least partly on a user's head position.

18. The non-transitory machine-readable medium of claim 17, wherein the grid structure includes a dot grid structure or a line grid structure.

19. The non-transitory machine-readable medium of claim 17, wherein the second user input includes a pinch gesture, and the third user input includes a drag gesture while maintaining the pinch gesture.

20. The non-transitory machine-readable medium of claim 17, wherein the instructions to place the selected widget at the position comprise instructions to move one or more pre-existing widgets within the grid structure.
